(19) United States
(12) Patent Application Publication
(10) Pub. No.: US 2021/0398477 A1
(43) Pub. Date: Dec. 23, 2021

(54) DISPLAY DRIVER AND POLARITY INVERSION METHOD THEREOF

(71) Applicant: Novatek Microelectronics Corp., Hsinchu (TW)

(72) Inventor: Te-Hsien Kuo, Keelung City (TW)

(73) Assignee: Novatek Microelectronics Corp., Hsinchu (TW)

(21) Appl. No.: 16/908,747

(22) Filed: Jun. 23, 2020

(51) Int. Cl. G09G 3/20

(52) U.S. Cl. CPC G09G 3/2092; G09G 2310/0275; G09G 2310/0254; G09G 2300/0823

(57) ABSTRACT

A display driver and a polarity inversion method thereof are provided. The display driver includes multiple channel pairs and a polarity inversion control circuit. The channel pairs are suitable for driving a display panel. Each of the channel pairs includes a positive polarity channel, a negative polarity channel, and a switching circuit. The polarity inversion control circuit controls the switching circuits so that the position where the polarity of a first data line of the display panel is inverted in a first frame period is different from the position where the polarity of the first data line is inverted in a second frame period. The display driver can prevent polarity inversion from occurring at a fixed position as much as possible.

### BACKGROUND

### Technical Field

The invention relates to a display apparatus, and particularly relates to a display driver and a polarity inversion method thereof.

### Description of Related Art

In a display apparatus, a source driver may drive a display panel under the control of a timing controller, so as to display an image frame. In order to prevent the properties of liquid crystal molecules from being damaged, the timing controller may control the source driver to invert the polarity. In the conventional N-line inversion or other polarity inversions, the position where polarity is inverted is fixed throughout different frame periods. In general, it is frequent to observe insufficient charging in the first sub-pixel unit (sub-pixel circuit) after the polarity is inverted. Therefore, the conventional polarity inversion may result in a dark line (or a bright line) at a fixed position on the display panel.

### SUMMARY

The invention provides a display driver and a polarity inversion method of the display driver. With the display driver and the polarity inversion method thereof, polarity inversion can be prevented from occurring at a fixed position as much as possible.

According to an embodiment of the invention, the display driver includes a plurality of channel pairs and a polarity inversion control circuit. The channel pairs are suitable for driving a display panel. Each of the channel pairs includes a positive polarity channel, a negative polarity channel, and a switching circuit. A first input end and a second input end of the switching circuit of a first channel pair in the channel pairs are respectively coupled to an output end of the positive polarity channel of the first channel pair and an output end of the negative polarity channel of the first channel pair. A first output end and a second output end of the switching circuit of the first channel pair are respectively coupled to a first data line and a second data line of the display panel. The polarity inversion control circuit is configured to control the switching circuits, so that a position where polarity of the first data line is inverted during a first frame period is different from a position where the polarity of the first data line is inverted during a second frame period after the first frame period.

According to an embodiment of the invention, the polarity inversion method includes: driving a display panel by a plurality of channel pairs; and controlling the switching circuits by the polarity inversion control circuit, so that a position where polarity of the first data line is inverted during a first frame period is different from a position where the polarity of the first data line is inverted during a second frame period after the first frame period.

Based on the above, in the embodiments of the invention, the display driver and the polarity inversion method of the display driver can prevent polarity inversion from occurring at a fixed position as much as possible. For example, the position where the polarity of the first data line is inverted during the previous frame period is different from the position where the polarity of the first data line is inverted in the subsequent frame period. Accordingly, it is difficult for human eyes to detect the insufficient charging of the first sub-pixel unit (sub-pixel circuit) after polarity inversion.

In order to make the aforementioned and other features and advantages of the invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic circuit block diagram illustrating a source driver according to an embodiment of the invention.

FIG. 2 is a schematic flowchart illustrating a polarity inversion method according to an embodiment of the invention.

### DESCRIPTION OF THE EMBODIMENTS

Throughout the specification (including claims), the term “couple” (or connect) may refer to any direct or indirect connection means. For example, if it is described that a first apparatus is coupled to (or connected to) a second apparatus, the first apparatus may be interpreted as being directly connected to the second apparatus, or the first apparatus may be interpreted as being indirectly connected to the second apparatus through another apparatus or through a connection means. Terms such as “first”, “second”, etc., mentioned throughout the specification (including claims) serve to name the elements or distinguish different embodiments or scopes, and shall not serve to limit the upper or lower limit of the quantity of element(s), nor serve to limit the order of elements. In addition, wherever possible, elements/components/steps labeled with the same reference symbols in the drawings and embodiments represent like or similar parts. Elements/components/steps labeled with the same reference symbols or named in the same manes in different embodiments may serve as reference with respect to each other.

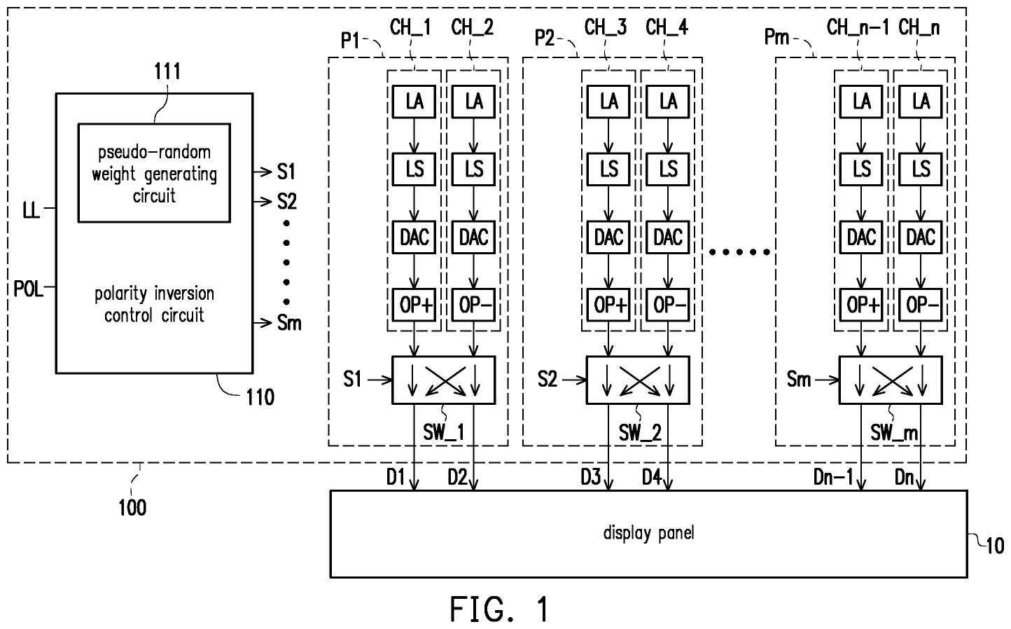

FIG. 1 is a schematic circuit block diagram illustrating a source driver 100 according to an embodiment of the invention. The display driver 100 shown in FIG. 1 may drive a display panel 10 to display an image frame under the control of a timing controller (not shown). The display driver 100 includes a plurality of channel pairs P1, P2, . . . , Pm, wherein m is an integer determined based on design needs.

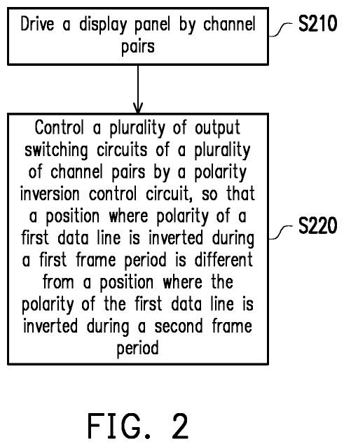

FIG. 2 is a schematic flowchart illustrating a polarity inversion method according to an embodiment of the invention. In Step S210, the channel pairs P1 to Pm may drive the display panel 10. The channel pair P1 includes a positive polarity channel CH_1, a negative polarity channel CH_2, and a switching circuit SW_1. The first input end and the second input end of the switching circuit SW_1 may be respectively coupled to the output end of the positive polarity channel CH_1 and the output end of the negative polarity channel CH_2. The channel pair P2 includes a positive polarity channel CH_3, a negative polarity channel CH_4, and a switching circuit SW_2. The first input end and the second input end of the switching circuit SW_2 may be respectively coupled to the output end of the positive polarity channel CH_3 and the output end of the negative polarity channel CH_4. Following the same principle, the channel pair Pm includes a positive polarity channel CH_n−1, a negative polarity channel CH_n, and a switching circuit SW_m, wherein n is an integer determined based on design needs. The first input end and the second input end of the switching circuit SW_m may be respectively coupled to the output end of the positive polarity channel CH_n−1 and the output end of the negative polarity channel CH_n. The first output ends and the second output ends of the switching circuits SW_1 to SW_m are coupled to data lines D1, D2, D3, D4, . . . , Dn−1, and Dn of the display panel 10.

In the embodiment shown in FIG. 1, each positive polarity channel (e.g., CH_1, CH_3, and CH_n−1) includes a latch LA, a level shifter LS, a digital to analog converter DAC, and a positive polarity amplifier OP+. The positive polarity amplifier OP+ serves to provide a positive polarity driving voltage to the corresponding data line of the display panel 10. Each negative polarity channel (e.g., CH_2, CH_4, and CH_n) includes a latch LA, a level shifter LS, a digital to analog converter DAC, and a negative polarity amplifier OP−. The negative polarity amplifier OP− serves to provide a negative polarity driving voltage to the corresponding data line of the display panel 10.

A polarity inversion control circuit 110 may receive a line latch signal LL and a polarity signal POL provided by the timing controller (not shown). The line latch signal LL may be a start pulse of a display line. Based on the line latch signal LL and the polarity signal POL, the polarity inversion control circuit 110 may output a plurality of switching control signals S1, S2, . . . , Sm to the switching circuits SW_1 to SW_m. For example, when the switching control signal S1 is at the first logic level (e.g., logic “0”), the switching circuit SW_1 may couple the output end of the positive polarity channel CH_1 to the data line D1 of the display panel 10, and couple the output end of the negative polarity channel CH_2 to the data line D2 of the display panel 10. When the switching control signal S1 is at the second logic level (e.g., logic “1”), the switching circuit SW_1 may couple the output end of the positive polarity channel CH_1 to the data line D2, and couple the output end of the negative polarity channel CH_2 to the data line D1. The arrangement of the remaining switching control signals S2 to Sm and the remaining switching circuits SW_2 and SW_m may be inferred based on the descriptions about the switching control signal S1 and the switching circuit SW_1. Therefore, details in this regard will not be repeated in the following.

In Step S220, the polarity inversion control circuit 110 may control the switching circuits SW_1 to SW_m, so that the position where the polarity of the data line D1 is inverted during the first frame period is different from the position where the polarity of the data line D1 is inverted during the second frame period. Details about other data lines D2 to Dn may be inferred based on the descriptions about the data line D1, and therefore will not be repeated in the following.

Within the same frame period, the polarity inversion control circuit 110 may control the switching circuits SW_1 to SWm, so that the position where the polarity of the data line D3 is inverted is different from the position where the polarity of the data line D1 is inverted. For example, Tables 1 to 4 describe the polarity configurations of some sub-pixel units (sub-pixel circuits) of the display panel 10 in different frame periods. In Table 1 to Table 4, “+” indicates that the polarity of the sub-pixel unit is positive, and “−” indicates that the polarity of the sub-pixel unit is negative. DL1, DL2, DL3, and DL4 shown in Tables 1 to 4 represent four display lines of the display panel 10, and D1, D2, D3, D4, D5, and D6 represent six display lines of the display panel 10. For the same data line, the change of polarity from “+” to “−” indicates polarity inversion, and the change of polarity from “−” to “+” also indicates polarity inversion. In Table 1 (frame period FP1), the polarity inversion control circuit 110 may control the switching circuits SW_1 to SWm, so that the position where the polarity of the data line D3 is inverted is different from the position where the polarity of the data line D1 is inverted.

TABLE 1
Polarity Configuration of Some Sub-pixel Units
of Display Panel 10 within Frame Period FP1

| | D1 | D2 | D3 | D4 | D5 | D6 |
|---|---|---|---|---|---|---|
| DL1 | + | − | + | − | + | − |
| DL2 | − | + | + | − | + | − |
| DL3 | − | + | − | + | + | − |
| DL4 | − | + | − | + | − | + |

TABLE 2
Polarity Configuration of Some Sub-pixel Units
of Display Panel 10 within Frame Period FP2

| | D1 | D2 | D3 | D4 | D5 | D6 |
|---|---|---|---|---|---|---|
| DL1 | − | + | − | + | − | + |
| DL2 | + | − | − | + | − | + |
| DL3 | + | − | + | − | − | + |
| DL4 | + | − | + | − | + | − |

TABLE 3
Polarity Configuration of Some Sub-pixel Units
of Display Panel 10 within Frame Period FP3

| | D1 | D2 | D3 | D4 | D5 | D6 |
|---|---|---|---|---|---|---|
| DL1 | − | + | − | + | − | + |
| DL2 | − | + | + | − | + | − |
| DL3 | − | + | + | − | + | − |
| DL4 | + | − | + | − | + | − |

TABLE 4
Polarity Configuration of Some Sub-pixel Units
of Display Panel 10 within Frame Period FP4

| | D1 | D2 | D3 | D4 | D5 | D6 |
|---|---|---|---|---|---|---|
| DL1 | + | − | + | − | + | − |
| DL2 | + | − | − | + | − | + |
| DL3 | + | − | − | + | − | + |
| DL4 | − | + | − | + | − | + |

The frame periods FP1, FP2, FP3, and FP4 are four consecutive frame periods. The positions where the polarity is inverted in the data lines D1 to D6 during the frame period FP1 are the same as the positions where the polarity is inverted in the data lines D1 to D6 during the frame period FP2 after the frame period FP1. The positions where the polarity is inverted in the data lines D1 to D6 during the frame period FP2 are different from the positions where the polarity is inverted in the data lines D1 to D6 during the frame period FP3 after the frame period FP2. The positions where the polarity is inverted in the data lines D1 to D6 during the frame period FP3 are the same as the positions where the polarity is inverted in the data lines D1 to D6 during the frame period FP4 after the frame period FP3.

Table 5 describes the polarity configuration of some sub-pixel units (sub-pixel circuits) of the display panel 10 during the same frame period in some other embodiments. DL1, DL2, DL3, DL4, DL5, DL6, DL7, and DL8 shown in Table 5 represent eight display lines of the display panel 10, and P1, P2, P3, P4, P5, P6, P7, P8, P9, P10, P11, and P12 represent 12 channel pairs. In Table 5, “0” represents that, in the two data lines connected with the channel pair, the polarity of the odd-numbered data line is positive, and the polarity of the even-numbered data line is negative. In Table 5, “1” represents that, in the two data lines connected with the channel pair, the polarity of the odd-numbered data line is negative, and the polarity of the even-numbered data line is positive. For the same channel pair, the change from “0” to “1” indicates polarity inversion, and the change from “1” to “0” also indicates polarity inversion.

TABLE 5
Polarity Configuration of Some Sub-
pixel Units of Display Panel 10

| | P1 | P2 | P3 | P4 | P5 | P6 | P7 | P8 | P9 | P10 | P11 | P12 |
|---|---|---|---|---|---|---|---|---|---|---|---|---|
| DL1 | 0 | 0 | 0 | 0 | 0 | 0 | 0 | 0 | 0 | 0 | 0 | 0 |
| DL2 | 1 | 0 | 0 | 0 | 0 | 0 | 0 | 0 | 1 | 0 | 1 | 0 |
| DL3 | 1 | 0 | 0 | 0 | 0 | 1 | 0 | 1 | 1 | 0 | 1 | 1 |
| DL4 | 1 | 0 | 0 | 1 | 1 | 1 | 0 | 0 | 1 | 0 | 1 | 1 |
| DL5 | 1 | 1 | 0 | 1 | 1 | 1 | 1 | 0 | 1 | 0 | 0 | 1 |
| DL6 | 1 | 1 | 0 | 1 | 1 | 1 | 1 | 1 | 0 | 1 | 0 | 1 |
| DL7 | 1 | 1 | 0 | 1 | 0 | 1 | 1 | 0 | 0 | 1 | 0 | 0 |
| DL8 | 1 | 1 | 1 | 0 | 0 | 0 | 1 | 0 | 0 | 1 | 0 | 0 |

In the embodiment shown in Table 5, the polarity inversion control circuit 110 may select at least one selected data line from the data lines of the display panel 10. The polarity inversion control circuit 110 may control the switching circuits SW_1 to SW_m, so that the polarity of the selected data line is inverted during the first display line period and the second display line period adjacent to each other. Based on the design needs, in the case where the polarity inversion mode of the display panel 10 is N-line inversion, when the number of the channel pairs P1 to Pm is M, the number of the selected data line is an integer of M/N.

For example, it is assumed that the polarity inversion mode of the display panel 10 is 4-line inversion, and it is assumed that the number M of the channel pairs P1 to Pm is 12. The polarity inversion control circuit 110 selects 3 (i.e., 12/4) data lines as the selected data lines from the data lines connected with the channel pairs P1 to Pm in each display line period. For example, the polarity inversion control circuit 110 may select the data lines connected with the channel pairs P1, P9, and P11 as the selected data lines. Therefore, during the display line period corresponding to the display line DL1 and the display line period corresponding to the display line DL2, the polarity inversion control circuit 110 may invert the polarity of the data lines connected with the channel pairs P1, P9, and P11, as shown in FIG. 5. Then, the polarity inversion control circuit 110 may select the data lines connected with the channel pairs P6, P8, and P12 as the selected data lines. Therefore, during the display line period corresponding to the display line DL2 and the display line period corresponding to the display line DL3, the polarity inversion control circuit 110 may invert the polarity of the data lines connected with the channel pairs P6, P8, and P12. Based on the same principle, during the display line period corresponding to the display line DL3 and the display line period corresponding to the display line DL4, the polarity inversion control circuit 110 may invert the polarity of the data lines connected with the channel pairs P4, P5, and P8.

Table 6 describes the polarity inversion weights of some sub-pixel units (sub-pixel circuits) of the display panel 10 within the same frame period in still some other embodiments. Details about the display lines DL1 to DL8 and the channel pairs P1 to P12 shown in Table 6 may be referred to relevant descriptions for Table 5. In the embodiment shown in Table 6, a pseudo-random weight generating circuit 111 of the polarity inversion control circuit 110 may determine the polarity inversion weight of each of the sub-pixel units of the display lines DL1 to DL8 of the display panel 10. Based on the design needs, the pseudo-random weight generating circuit 111 may include a pseudo-random binary sequence (PRBS) circuit and/or a linear feedback shift register (LFSR). In Table 5, w1 to w96 represent different polarity inversion weights. A polarity inversion weight w1 is the polarity inversion weight of the sub-pixel unit connected with the channel pair P1 and connected with the display line DL1, and details about other polarity inversion weights w2 to w98 may be inferred with reference to the polarity inversion weight w1.

TABLE 6
Polarity Inversion Weights of Some Sub-pixel Units of Display Panel 10

| | P1 | P2 | P3 | P4 | P5 | P6 | P7 | P8 | P9 | P10 | P11 | P12 |
|---|---|---|---|---|---|---|---|---|---|---|---|---|
| DL1 | w1 | w2 | w3 | w4 | w5 | w6 | w7 | w8 | w9 | w10 | w11 | w12 |
| DL2 | w13 | w14 | w15 | w16 | w17 | w18 | w19 | w20 | w21 | w22 | w23 | w24 |
| DL3 | w25 | w26 | w27 | w28 | w29 | w30 | w31 | w32 | w33 | w34 | w35 | w36 |
| DL4 | w37 | w38 | w39 | w40 | w41 | w42 | w43 | w44 | w45 | w46 | w47 | w48 |
| DL5 | w49 | w50 | w51 | w52 | w53 | w54 | w55 | w56 | w57 | w58 | w59 | w60 |
| DL6 | w61 | w62 | w63 | w64 | w65 | w66 | w67 | w68 | w69 | w70 | w71 | w72 |
| DL7 | w73 | w74 | w75 | w76 | w77 | w78 | w79 | w80 | w81 | w82 | w83 | w84 |
| DL8 | w85 | w86 | w87 | w88 | w89 | w90 | w91 | w92 | w93 | w94 | w95 | w96 |

In the embodiment shown in Table 6, the polarity inversion control circuit 110 may select at least one selected data line from the data lines of the display panel 10 based on the polarity inversion weights of the sub-pixel units on the same display line. The polarity inversion control circuit 110 may control the switching circuits SW_1 to SW_m, so that the polarity of the selected data line is inverted during the first display line period and the second display line period adjacent to each other. Based on the design needs, in the case where the polarity inversion mode of the display panel 10 is N-line inversion, when the number of the channel pairs P1 to Pm is M, the number of the selected data line is an integer of M/N. Based on the design needs, in some embodiments, on the same display line, the polarity inversion weights of the sub-pixel units connected with the selected data lines are greater than the polarity inversion weights of other sub-pixel units. In some other embodiments, on the same display line, the polarity inversion weights of the sub-pixel units connected with the selected data lines are smaller than the polarity inversion weights of other sub-pixel units.

For example, it is assumed that the polarity inversion mode of the display panel 10 is 4-line inversion, and it is assumed that the number M of the channel pairs P1 to Pm is 12. Based on the polarity inversion weights of the sub-pixel units on the same display line, the polarity inversion control circuit 110 selects 3 (i.e., 12/4) data lines as the selected data lines from the data lines connected with the channel pairs P1 to Pm in each display line period. For example, the polarity inversion control circuit 110 may select three sets of data lines (e.g., the data lines connected with the channel pairs P1, P9, and P11) with the maximum weights as the selected data lines based on the polarity inversion weights w1 to w12 of the sub-pixel units on the display line DLL In other words, the polarity inversion weights w1, w9, and w11 are greater than the polarity inversion weights w2 to w8, w10, and w12. Based on the design needs, the polarity inversion control circuit 110 may select the set (or multiple sets) of data lines with the minimum weight as the selected data lines according to the polarity inversion weights w1 to w12. During the display line period corresponding to the display line DL1 and the display line period corresponding to the display line DL2, the polarity inversion control circuit 110 may invert the polarity of the data lines connected with the channel pairs P1, P9, and P11.

Then, the polarity inversion control circuit 110 may select three sets of data lines (e.g., the data lines connected with the channel pairs P6, P8, and P12) with the maximum weights as the selected data lines based on the polarity inversion weights w13 to w24 of the sub-pixel units on the display line DL2. During the display line period corresponding to the display line DL2 and the display line period corresponding to the display line DL3, the polarity inversion control circuit 110 may invert the polarity of the data lines connected with the channel pairs P6, P8, and P12. The operation of the polarity inversion control circuit 110 on other display lines DL3 to DL8 may be inferred based on the descriptions about the display lines DL1 to DL2. Therefore, details in this regard will not be repeated in the following.

The polarity inversion control circuit 110 may control the switching circuits SW_1 to SW_m, so that the configuration of the polarity inversion weights w1 to w96 of the sub-pixel units of the display panel 10 in the previous frame period is different from the configuration of the polarity inversion weights w1 to w96 of the sub-pixel units of the display panel 10 in the subsequent frame period. For example, the configuration of the polarity inversion weights w1 to w96 of the sub-pixel units of the display panel 10 in the n^{th} frame period may be the same as the configuration of the polarity inversion weights w1 to w96 of the sub-pixel units of the display panel 10 in the n+1^{th} frame period, the configuration of the polarity inversion weights w1 to w96 of the sub-pixel units of the display panel 10 in the n+1^{th} frame period may be the different from the configuration of the polarity inversion weights w1 to w96 of the sub-pixel units of the display panel 10 in the n+2^{th} frame period, and the configuration of the polarity inversion weights w1 to w96 of the sub-pixel units of the display panel 10 in the n+2^{th} frame period may be the same as the configuration of the polarity inversion weights w1 to w96 of the sub-pixel units of the display panel 10 in the n+3^{th} frame period.

Based on different design needs, the blocks of the polarity inversion control circuit 110 and/or the pseudo-random weight generating circuit 111 may be implemented as hardware, firmware, software (i.e., programs), or a combination of multiple ones of the aforementioned.

In the form of hardware, the blocks of the polarity inversion control circuit 110 and/or the pseudo-random weight generating circuit 111 may be implemented in logic circuits on an integrated circuit. Relevant functions of the polarity inversion control circuit 110 and/or the pseudo-random weight generating circuit 111 may be implemented, as hardware components, by using hardware description languages (e.g., verilog DHL or VDHL) or other suitable programming languages. For example, relevant functions of the polarity inversion control circuit 110 and/or the pseudo-random weight generating circuit 111 may be realized as one or more controllers, microcontrollers, microprocessors, application-specific integrated circuits (ASICs), digital signal processors (DSPs), field programmable gate arrays (FPGAs), and/or various logic blocks, modules and circuits in other processors.

As for the form of software and/or firmware, relevant functions of the polarity inversion control circuit 110 and/or the pseudo-random weight generating circuit 111 may be implemented as programming codes. For example, the polarity inversion control circuit 110 and/or the pseudo-random weight generating circuit 111 may be realized by using conventional programming languages (e.g., C, C++, or assembly languages) or other suitable programming languages. The programming codes may be recorded/stored in a recording medium. In some embodiments, the recording medium includes, for example, a read only memory (ROM), a storage apparatus, and/or a random access memory (RAM). In some other embodiments, the recording medium may include a non-transitory computer readable medium. For example, tapes, disks, cards, semiconductor memories, programmable logic circuits, etc., may be used to realize the non-transitory computer readable medium. The controller, microcontroller, or microprocessor may read the programming codes from the recording medium and execute the programming codes, so as to realize relevant functions of the polarity inversion control circuit 110 and/or the pseudo-random weight generating circuit 111. In addition, the programming codes may be provided to the computer (or CPU) via an arbitrary transmission medium (a communication network or broadcast radio waves, etc.). The communication network may be the Internet, a wired communication network, a wireless communication network, or other communication media.

In view of the foregoing, the display driver 100 and the polarity inversion method of the display driver 100 according to the embodiments can prevent polarity inversion from occurring at a fixed position as much as possible. For example, the position where the polarity of the data line D1 is inverted during the previous frame period is different from the position where the polarity of the data line D1 is inverted in the subsequent frame period. Details about other data lines D2 to Dn may be inferred based on the descriptions about the data line D1, and therefore will not be repeated in the following. Accordingly, it is difficult for human eyes to detect the insufficient charging of the first sub-pixel unit (sub-pixel circuit) after polarity inversion.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

1. A display driver, comprising:
a plurality of channel pairs, suitable for driving a display panel, wherein each of the channel pairs comprises a positive polarity channel, a negative polarity channel, and a switching circuit, a first input end and a second input end of the switching circuit of a first channel pair in the channel pairs are respectively coupled to an output end of the positive polarity channel of the first channel pair and an output end of the negative polarity channel of the first channel pair, and a first output end and a second output end of the switching circuit of the first channel pair are respectively and directly coupled to a first data line and a second data line of the display panel; and
a polarity inversion control circuit, configured to control all of the switching circuits at the same time, so that a position where polarity of the first data line is inverted during a first frame period is different from a position where the polarity of the first data line is inverted during a second frame period after the first frame period.

2. The display driver as claimed in claim 1, wherein a third frame period is present between the first frame period and the second frame period.

3. The display driver as claimed in claim 2, wherein the position where the polarity of the first data line is inverted during the first frame period is the same as a position where the polarity of the first data line is inverted during the third frame period.

4. The display driver as claimed in claim 1, wherein a first input end and a second input end of the switching circuit of a second channel pair of the channel pairs are respectively coupled to an output end of the positive polarity channel of the second channel pair and an output end of the negative polarity channel of the second channel pair, a first output end and a second output end of the switching circuit of the second channel pair are respectively coupled to a third data line and a fourth data line of the display panel, and the polarity inversion control circuit is configured so that a position where polarity of the third data line is inverted in the same first frame period is different from the position where the polarity of the first data line is inverted in the same first frame period.

5. The display driver as claimed in claim 1, wherein the polarity inversion control circuit selects at least one first selected data line from a plurality of data lines of the display panel, and the polarity inversion control circuit controls the switching circuits, so that polarity of the at least one first selected data line is inverted during a first display line period and a second display line period adjacent to each other.

6. The display driver as claimed in claim 5, wherein in a case where a polarity inversion mode of the display panel is N-line inversion, when the number of the channel pairs is M, the number of the at least one first selected data line is an integer of M/N.

7. The display driver as claimed in claim 5, wherein a pseudo-random weight generating circuit of the polarity inversion control circuit determines a polarity inversion weight of each of a plurality of sub-pixel units on a plurality of display lines of the display panel, and the polarity inversion control circuit selects the at least one first selected data line from the data lines of the display panel according to the polarity inversion weights of the sub-pixel units on a first display line of the display lines.

8. The display driver as claimed in claim 7, wherein the pseudo-random weight generating circuit comprises a pseudo-random binary sequence circuit or a linear feedback shift register.

9. The display driver as claimed in claim 7, wherein the polarity inversion weights of the sub-pixel units located on the first display line and connected with the at least one first selected data line are greater than the polarity inversion weights of other sub-pixel units on the first display line.

10. The display driver as claimed in claim 7, wherein the polarity inversion control circuit selects at least one second selected data line from the plurality of data lines according to the polarity inversion weights of the sub-pixel units on a second display line of the display lines, and the polarity inversion control circuit is configured so that polarity of the second selected data line is inverted during the second display line period and a third display line period adjacent to each other.

11. The display driver as claimed in claim 7, wherein a configuration of the polarity inversion weights of the sub-pixel units of the display panel during the first frame period is different from a configuration of the polarity inversion weights of the sub-pixel units of the display panel during the second frame period.

12. A polarity inversion method, comprising:
driving a display panel by a plurality of channel pairs, wherein each of the channel pairs comprises a positive polarity channel, a negative polarity channel, and a switching circuit, a first input end and a second input end of the switching circuit of a first channel pair in the channel pairs are respectively coupled to an output end of the positive polarity channel of the first channel pair and an output end of the negative polarity channel of the first channel pair, and a first output end and a second output end of the switching circuit of the first channel pair are respectively and directly coupled to a first data line and a second data line of the display panel; and
controlling all of the switching circuits at the same time by a polarity inversion control circuit, so that a position where polarity of the first data line is inverted during a first frame period is different from a position where the polarity of the first data line is inverted during a second frame period after the first frame period.

13. The polarity inversion method as claimed in claim 12, wherein a third frame period is present between the first frame period and the second frame period.

14. The polarity inversion method as claimed in claim 13, further comprising:
controlling the switching circuits by the polarity inversion control circuit, so that the position where the polarity of the first data line is inverted during the first frame period is the same as a position where the polarity of the first data line is inverted during the third frame period.

15. The polarity inversion method as claimed in claim 12, wherein a first input end and a second input end of the switching circuit of a second channel pair in the channel pairs are respectively coupled to an output end of the positive polarity channel of the second channel pair and an output end of the negative polarity channel of the second channel pair, and a first output end and a second output end of the switching circuit of the second channel pair are respectively coupled to a third data line and a fourth data line of the display panel, and the polarity inversion method further comprises:
controlling the switching circuits by the polarity inversion control circuit, so that within the same first frame period, a position where polarity of the third data line is inverted is different from the position where the polarity of the first data line is inverted.

16. The polarity inversion method as claimed in claim 12, further comprising:
selecting at least one first selected data line from a plurality of data lines of the display panel by the polarity inversion control circuit; and
controlling the switching circuits by the polarity inversion control circuit, so that polarity of the at least one first selected data line is inverted during a first display line period and a second display line period adjacent to each other.

17. The polarity inversion method as claimed in claim 16, wherein
in a case where a polarity inversion mode of the display panel is N-line inversion, when the number of the channel pairs is M, the number of the at least one first selected data line is an integer of M/N.

18. The polarity inversion method as claimed in claim 16, further comprising:
determining a polarity inversion weight of each of a plurality of sub-pixel units on a plurality of display lines of the display panel by a pseudo-random weight generating circuit of the polarity inversion control circuit; and
selecting the at least one first selected data line from the data lines of the display panel by the polarity inversion control circuit based on the polarity inversion weights of the sub-pixel units on a first display line of the display lines.

19. The polarity inversion method as claimed in claim 18, wherein the pseudo-random weight generating circuit comprises a pseudo-random binary sequence circuit or a linear feedback shift register.

20. The polarity inversion method as claimed in claim 18, wherein the polarity inversion weights of the sub-pixel units located on the first display line and connected with the at least one first selected data line are greater than the polarity inversion weights of other sub-pixel units on the first display line.

21. The polarity inversion method as claimed in claim 18, further comprising:
selecting at least one second selected data line from the data lines by the polarity inversion control circuit based on the polarity inversion weights of the sub-pixel units on a second display line of the display lines; and
controlling the switching circuits by the polarity inversion control circuit, so that polarity of the at least one second selected data line is inverted during the second display line period and a third display line period adjacent to each other.

22. The polarity inversion method as claimed in claim 18, wherein a configuration of the polarity inversion weights of the sub-pixel units of the display panel during the first frame period is different from a configuration of the polarity inversion weights of the sub-pixel units of the display panel during the second frame period.
